(19) United States
(12) Patent Application Publication
(10) Pub. No.: US 2006/0228528 A1
(43) Pub. Date: Oct. 12, 2006

(54) Deep draw process for flame retardant materials

(76) Inventors: Eberhard Link, Raleigh, NC (US); Charles R. Mason, Nashua, NH (US); Amelia Tosti, Durham, NC (US); James Frasch, Hollis, NH (US); Ashutosh P. Karnik, Andover, MA (US); Gregory Grissett, Greensboro, NC (US); Chad Graham, Cary, NC (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/263,082

(22) Filed: Oct. 31, 2005

Related U.S. Application Data
(60) Provisional application No. 60/623,599, filed on Oct. 29, 2004.

(51) Int. Cl. B32B 3/28

(52) U.S. Cl. 428/180

(57) ABSTRACT

The present invention relates to a fire blocking non-woven three-dimensional structure. The structure may include a fabric having a multiplicity of compressible projections wherein the projections return substantially to their original shape after being compressed by 50%. The fabric may include a layer of non-woven and/or metallic film or foil fire blocking material.

### CROSS REFERENCE TO RELATED APPLICATIONS

The present application claims the benefit of the filing date of U.S. Provisional Application Ser. No. 60/623,599 filed Oct. 29, 2004, the teachings of which are incorporated herein by reference.

### FIELD OF INVENTION

The present invention relates to three-dimensional materials and structures. More particularly, the present invention relates to the use of flame retardant and/or metallic materials to form three-dimensional materials and structures.

### BACKGROUND

It is known in the textile industry to produce three-dimensional fiber networks for use in applications including automobile seats, shoes, cast padding, orthopedic lining materials, or other applications requiring properties such as cushioning, impact resistant and resiliency.

Examples of three-dimensional fiber networks include, but are not limited to the following. U.S. Pat. No. 5,731,062 discusses a three dimensional fiber network consisting of a textile fabric having a multiplicity of compressible projections that may incorporate a number of shapes, i.e., cones, truncated cones, pyramids, cylinders, prisms, etc., composed of thermoplastic filaments. U.S. Pat. No. 5,851,930 discloses a three-dimensional shaped fiber network structure composed of a deformed textile fabric containing at least one oriented, semi-crystalline mono-filament yarn containing a thermoplastic polymer and a cured crosslinkable resin impregnating the deformed fabric so as to effect bonding of all or substantially all of the monofilament crossover points.

Examples of how fiber networks are applied include, but are not limited to the following. U.S. Pat. No. 5,833,321 discloses an automobile seat having a spacer layer comprising one or more layers of a three-dimensional fiber network. The fiber network may be composed of a knit or non woven textile fabric. U.S. Pat. No. 5,882,322 discloses cast padding material and padding and lining materials for other orthopedic devices made from three-dimensional fiber networks. U.S. Pat. No. 5,896,680 discloses the use of three-dimensional fiber networks in shoes.

It is also known in the textile industry to incorporate flame retarding additives and reactants in the polymers used in three-dimensional structures such as aluminum trihydrate, organochlorine compounds, organobromine compounds, organophosphorous compounds, antimony oxides and boron compounds. Other flame retardants that may be used include intumescent coatings, sulfur or sulfur compounds and oxides and carbonates of bismuth, tin iron and molybdenum.

Numerous disclosures have been aimed at modifying the burning characteristics of fiber materials. For example, in U.S. Pat. No. 4,600,606 a method of flame retarding textile and related fibrous materials is reported, which relies upon the use of a water-insoluble, non-phosphorous containing brominated aromatic or cycloaliphatic compounds along with a metal oxide. U.S. Pat. No. 4,026,808 reports on the use of a phosphorous containing N-hydroxymethyl amide and tetrakis (hydroxymethyl) phosphonium chloride. U.S. Pat. No. 3,955,032 confirms the use of chlorinated-cyclopentadieno compounds, chlorobrominated-cyclpentadieno compounds, either alone or in combination with metal oxides.

U.S. Pat. No. 4,702,861 describes a flame retardant composition for application as an aqueous working dispersion onto surfaces of combustible materials. Upon exposure to elevated temperatures and/or flame, the formulation reportedly creates a substantially continuous protective film generally encapsulating and/or enveloping the surface of the article onto which it is applied. The film-forming materials are based upon an aqueous latex dispersion of polyvinylchloride-acrylic copolymer together with certain other film-forming and viscosity controlling components.

Other disclosures which offer additional background information include U.S. Pat. No. 4,776,854 entitled “Method for Flameproofing Cellulosic Fibrous Materials”; U.S. Pat. No. 5,051,111 entitled “Fibrous Material”; U.S. Pat. No. 5,569,528 entitled “Treating Agent for Cellulosic Textile Material and Process for Treating Cellulosic Textile Material”; and U.S. Pat. No. 6,309,565 entitled “Formaldehyde-Free Flame Retardant Treatment for Cellulose-Containing Materials”.

It is also worth mentioning that within the various efforts to provide flame resistant fabric products, various polymers themselves have emerged as substrates for use as flame resistant fibers. For example, melamine and melamine/formaldehyde based resinous fibers are said to display desirable heat stability, solvent resistance, low flammability and high-wear characteristics. One form of melamine/formaldehyde fiber is marketed under the tradename Basofil™. In addition, the aromatic polyamide family or aramids reportedly have high strength, toughness, and thermal stability. Aramid fibers are marketed under the tradenames Nomex™ and Kevlar™.

Furthermore, acrylic fibers are well-known in the synthetic fiber and fabric industries, as are the modified acrylic fibers (modacrylic). Such modacrylics are relatively inexpensive, and have been used in various blends with the fibers noted above to provide fire-resistant fabric material. One particular modacrylic fiber is sold under the tradename Kanecaron™ Protex, which is available from Kaneka Corporation, Japan.

In addition, flame retardant viscose fibers have become available, and one particular viscose fiber is sold under the tradename Visil™. More specifically, Visil™ is said to comprise a silicic acid containing viscose, with a limiting oxygen index (i.e., the minimum concentration of oxygen necessary to support combustion) in the range of 27-35, depending upon a particular textile construction.

Finally, it is worth noting that various manufacturers have produced and sold fire-resistant fabric material. They include as follows: 1. E. R. Carpenter's “Fire Stop™”, which relies upon Basofil™/modacrylic high loft batting; 2. Chiquola Industrial Fabric's “FireGuard™” which relies upon core spun flame retardant yarns into woven or knit form; 3. ChemTick Coated Fabrics “Flame Safe™” which relies upon core spun yarn in woven configuration with flame retardant treatment; 4. Elk Corporation's “VersaShield™” which relies upon a woven fiberglass base with a soft foam like coating on one side; 5. Jones Fiber Products, Inc.'s “T-Bond™” which relates to a flame retardant treatment of cotton batting; 6. Legett & Platt's “Pyro-Gon™” which is a batting of a blend of Pyron (panox) fibers with other fibers; 7. MLM, LLC's “Allesandra” which is a core spun flame retardant yarn in woven form; 8. Tex Tech's various blends of Basofil™ and Nomex™, Kevlar™ and PBI in the form of needle punched felts; and 9. Ventex's “Integrity 30™”, SpunGold™ and AKTIV™ which collectively relate to various products of knits and non-woven battings that may include Basofil™, Panox, Kevlar™ or Nomex™.

It is therefore an object of the present invention to expand upon the technology directed at the manufacture of flame retardant materials.

It is also an object of the present invention to provide a fire-resistant material of a non-woven three-dimensional fiber network structure.

### SUMMARY

An aspect of the present invention relates to a fire blocking non-woven three-dimensional structure that may include a fabric having a multiplicity of compressible textile projections. The fabric may include a layer of fire blocking non-woven material and or a metallic film or foil. The projections may return substantially to their original shape after being compressed by 50%.

In an aspect of the present invention, the fire blocking layer may include three components. The first component may be a polyacrylonitrile copolymer with a halogen containing monomer. The second component may be a viscose fiber containing silicic acid or a melamine/formaldehyde fiber or a regenerated cellulose fiber. The third component may be an aramid fiber or a melamine formaldehyde fiber or a polyester fiber.

In another aspect of the present invention, the fire blocking layer may include a needle-punched web including an aramid fiber. The needle punched web may be attached to a spunbond, melt blown or spunbond/meltblown composite web.

In a further aspect of the present invention, the fire blocking layer may include a first carded web of aramid and/or melamine/formaldehyde fiber and a second carded web of a polyacrylonitrile copolymer with a halogen comonomer and a polyester polymer. The webs may be needle punched together.

In another aspect of the present invention, the fire blocking layer may include a first carded web of aramide fiber and/or melamine/formaldehyde fiber and as second carded web including a binder fiber and a polyester polymer. The two webs may contact.

In a further aspect of the present invention, the fire blocking layer may include melamine and aramid fibers.

In yet another aspect of the present invention, the fabric may include a layer of polyester/polyamide blend material, mattress ticking or spunweb thermoplastic material. The fabric may also include an adhesive.

### DETAILED DESCRIPTION

The present invention relates to three-dimensional materials and structures incorporating flame retardant or metallic materials. These networks may generally be made by deforming a textile structure into the desired shape at a temperature high enough that the fibers, for example, can be permanently deformed into a rigid three-dimensional shaped network. Along such lines, reference is made to U.S. Pat. Nos. 5,731,062 and 5,851,930, the teachings of which are incorporated by reference.

The deformation may be brought about using a thermomechanical process, which means that mechanical force is applied at elevated temperatures. The mechanical force may be applied using numerous methods including, but not limited to, solid phase pressure forming, vacuum bladder match plate molding, interdigitation, deep drawing, use of a heated mold, etc. Heat and pressure may be applied for a sufficient period of time such that the textile fabric is permanently deformed, but not for such a long time or at such a long temperature that the filaments coalesce, causing the shaped fiber network, for example, to lose its resilience.

In a preferred embodiment a fabric results from the deforming process that may include a multiplicity of projections. The projections may be compressible. The projections may also be of a variety of shapes including, but not limited to hemispheric, conical, frustu-conical, or pyramidal. The projections may also be spaced to create a variety of visual patterns and designs in the fabric.

Accordingly, in the context of the present invention, the three-dimensional fiber network comprises compressible projections which return substantially to their original shape after being compressed by 50%, where the filaments preferably have a diameter of about 0.1 mm, and the filaments cross one another at intersections, the filaments and intersections preferably not being bonded. In addition, the present invention may utilize fibers of filaments that are smaller than 0.1 mm in diameter.

The three-dimensional fiber networks of the present invention may use a number of materials, including flame retardant fibers, supporting layers, metallic layers, and/or binder materials. The materials may be combined to form one or more layers resulting in a fire retardant fabric. The fabric may then be deformed as described above or the individual layers may be deformed prior to forming the fabric.

Examples of flame retardant fibers may include modacrylic fibers, viscose fibers, regenerated cellulose fibers, aramid fibers, or melamine and/or formaldehyde fibers. The fibers may be used individually or combined with other fibers to form one or more layers of flame retardant fabric. Exemplary fibers will be described herein.

Modacrylic fiber may be based upon a polyacrylonitrile copolymer with a halogen containing comonomer. The halogen containing comonomer may be poly(vinyl chloride) or poly(vinylidine chloride). An exemplary modacrylic fiber is available from Kaneka Corporation, under the tradename Kanecaron™ Protex. In particular, the modacrylic employed herein is sold under the tradename Kanecaron™ Protex PBX, having a specific gravity of 1.45-1.60 with a fiber denier of 2.2 dtex×38 mm. Protex PBX is described as having the following chemical components: acrylonitrile, vinylidine chloride copolymer, antimony oxide.

Viscose fiber is a general reference to a fiber produced by the viscose process in which cellulose is chemically converted into a compound for ultimate formation into a fiber material. An exemplary viscose fiber containing silicic acid is sold under the tradename Visil™, available from Sateri Oy, Inc. The Visil™ fiber is type AP 33, 3.5 dtex×50 mm. It is composed of 65-75% regenerated cellulose, 25-35% silicic acid and 2-5% aluminum hydroxide. An exemplary melamine/formaldehyde fiber component is sold under the tradename Basofil™, available from McKinnon-Land-Moran, LLC.

The regenerated cellulose fiber is generally a reference to cellulose that is first converted into a form suitable for fiber preparation (e.g. xanthation) and regenerated into the cellulose fiber form. The regenerated cellulose fiber may be prepared from wood pulp, e.g. lyocell fiber. Lyocell fiber herein is broadly defined herein as one example of a synthetic fiber produced from cellulosic substances. Lyocell is reportedly obtained by placing raw cellulose in an amine oxide solvent, the solution is filtered, extruded into an aqueous bath of dilute amine oxide, and coagulated into fiber form. From a property perspective, lyocell is also described as being a relatively soft, strong and absorbent fiber, with excellent wet strength, that happens to be wrinkle resistant, dyable to a number of colors, simulate silk or suede and maintains good drapabiltiy.

Aramid fiber is reference to an aromatic polyamide type fiber material, such as a poly (p-phenylene terephthalamide) made by E.I. DuPont de Nemours & Co., sold under the tradename Kevlar®. Aramid fiber may also be a reference to an aromatic polyamide type fiber material, such as poly (m-phenylene terephthalamide) made by E.I. DuPont de Nemours & Co., sold under the tradename Nomex®. The aramid fiber may be present at a level of less than or equal to 90.0% wt., including all percentages and ranges therein.

The supporting layers may be composed of mattress ticking, polyolefin or polyester spunbond webs or polyester/polyamide blends. The mattress ticking may be cotton, cotton/polyester, rayon/polyester, rayon/cotton/polyester, rayon/cotton/polypropylene, rayon/polypropylene blends or a 100% polypropylene. Furthermore the mattress ticking may be woven or knitted. In addition the mattress ticking may be impregnated with a binder to stabilize the weave structure. Preferably, the binder contains acrylic polymers.

The polyester spunweb may be between 30 to 150 g/m² basis weight. The polyester may be polyethylene terephthalate. The polyester spunweb may include one or more polyester fiber components including polyester and copolyester fibers having a denier between 1-5. The polyester fibers may be present in the web between 70-90% by weight and the copolyester fibers may be present in the web between 10-30% by weight. The polyester may have a glass transition temperature of between 65 to 80 degrees Celsius and the copolyester may have a glass transition temperature within 10 degrees Celsius of the glass transition temperature of the polyester. Exemplary polyester fiber component material may be obtained from Invista, Wichita Kans. under the trade name Invista.

The polyolefin spunweb may be between 10-70 g/m² basis weight. Exemplary polyolefin spunweb is available from Freudenberg, Weinheim, Germany and sold under the tradename Viledon®. The polyolefin fiber may have a denier of between 1 and 5 and the polyolefin may be a polypropylene. Those of skill in the art will recognize that a spunbond web material is a general reference to spunlaid technology in which the filaments have been extruded, drawn and laid on a moving belt to form a web.

Accordingly, a polymer suitable for the formation of spunbond material may be introduced into an extruder, output to a spinning die, and collected on a web laydown belt and calendar bonded to form a web. In related fashion, a melt blown web material is a general reference to a non-woven web forming process that extrudes and draws molten polymer resin with heated, relatively high velocity air to form fine filaments. The filaments are cooled and collected as a web onto a moving belt. While similar to the spunbond process, the melt blown fibers tend to be finer and more generally measured in microns. Accordingly, melt blowing is another form of a spunlaid process.

The polyester/polyamide blend may be a non-woven spunbond hydroentangled bicomponent microfiber product. The non-woven polyester/polyamide blend may also be formed from endless filaments. The non-woven polyester/polyamide blend may include polyester and nylon 6. The non-woven polyester/polyamide blend may have a basis weight of 5-300 g/m², including all increments therebetween at a 1 g/m² variation. It should be appreciated that the non-woven polyester/polyamide blend may be dyed a variety of colors, printed, sanded or softened.

The metallic film or foil may be, but is not limited to an aluminum foil. The film or foil may have a thickness of between 0.006 to 1.2 mm. The film or foil may also be treated so as to enhance puncture resistance and tear strength under tension. An exemplary film or foil is available from Alcoa or Nanhai Zhongnan Aluminum Co. Ltd. Alternatively, the metallic film or foil may be an aluminum coated polyester film or a polyester fibrous substrate where the coating film thickness of the aluminum is at least 0.001 mm.

The binder may include a polymer binder fiber incorporated in the layers of the non-woven textile or added as a layer in between the layers of materials described herein. The binder may have melt temperatures correlating to the processing temperatures of the various components of the three-dimensional fiber network and may have the capability to melt bond with the various fiber components. More preferably, the binder may have a melting temperature within the range of 50-300° C., including all increments therebetween, such as 80-240° C.

The binder may be in the form of a powder, web or fibers. Fibers may be in the form of a sheath/core, side-by-side, or monofilament configuration. The adhesive may include for example, polyamide fibers which may be melt-spun or spunbond. The polyamide fibers in one embodiment may include a copolyamide fiber. The copolyamide fiber may have a glass transition temperature of between 105-115° C. as measured by DSC and a melt viscosity of 500 Pa-s at 160° C. and 2.16 kg as measured by ISO 1133. The binder may also have a basis weight of between 20-35 grams per square meter. The copolyamide fibers may be available from EMSGriltech, Sumter, S.C. under the trade name Griltex®.

The binder may also include one or a plurality of polymer components. A multiple component binder fiber may be, for example, 4 d×2″ from either Nan Ya or Sam Yang in Korea with the outer layer having a melting point of 150° C., which melting point is lower than the melting point of the inner layer of this particular binder fiber material. The binder fiber outer layer melts and flows onto the other fibers bonding the structure together.

As alluded to above, the flame retardant material may be composed of a variety of the materials and fiber components discussed herein. In one exemplary embodiment, the flame retardant material may be a needle punched textile structure composed of a first fiber component of modacrylic fibers, a second fiber of either viscose fiber containing silicic acid, regenerated cellulose fiber or a melamine/formaldehyde fiber or mixtures thereof and a third fiber component of either aramid fiber, melamine/formaldehyde fiber, or polyester fiber or mixtures thereof.

The above referenced fire blocking non-woven textile therefore may contain the modacrylic polymer component (e.g., polyacrylonitrile copolymer with poly(vinylidine chloride)) at levels of about 30-80% (wt.), the second fiber component which supports the modacrylic component may be present at about 10-50% (wt.) and the third fiber component may be present at a level of about 10-30% (wt.). In another exemplary embodiment, the modacrylic component may be present at about 70% (wt.) and the second fiber component may be a viscose fiber containing silicic acid and/or a melamine/formaldehyde polymer, present at about 20% (wt.). In context of all of these ranges, it should be understood that within the broad scope of this invention, all increments therebetween are included at 1% (wt.) variation.

In addition, preferably, the denier of the fibers may be configured in the range of about 1-15 denier, including all increments and ranges therebetween. Preferably, the flame retardant non-woven material will also have a basis weight of 100-500 g/m², including all increments therebetween at 1 g/m² variation. The basis weight of any such fire blocking textile structure disclosed may be in the range of about 100-350 g/m².

In another embodiment, the flame retardant material may be composed of a needle punched web including an aramid fiber, which is attached to a spunbond, meltblown or spunbond/meltblown composite web material. The spunbond, meltblown or spunbond/meltblown composite web may be attached to the aramid fiber web by needle punching. The spunbond, meltblown or spunbond/meltblown composite web may be a polyolefin or a polyester material and the polyolefin material may be polyolefin a polypropylene. The needle punched web including the aramid fiber may also include a polyacrylonitrile copolymer with a halogen containing monomer and a second fiber component comprising a viscose fiber containing silicic acid.

In another embodiment, the flame retardant material may be composed of a carded web of an aramid fiber and/or a melamine/formaldehyde fiber and a second carded web of a polyacrylonitrile copolymer with a halogen containing monomer and a polyester. The two webs may be needle punched together.

In another embodiment, the flame retardant material may be composed of a carded web of an aramid fiber and/or a melamine/formaldehyde fiber and a second carded web of a binder fiber blended with a polyester, the second carded web contacting the first carded web. The two webs may be needle punched together. The second carded web may also include natural fibers and/or a polyacrylonitrile copolymer with a halogen monomer. The natural fibers may comprise wool and/or cotton.

In another embodiment, the flame retardant material may be composed of melamine and aramid fibers that may be hydroentangled or spunlaced. The aramid fibers may be present between 10-90% by weight of the material and the melamine fibers may be present between 10-90% by weight of the material. Furthermore, the aramid fibers may be para-aramid and/or meta-aramid fibers. In one exemplary embodiment, the para-aramid fibers may be present between 20-30% by weight of the material and the meta-aramid fibers may be present between 20-30% by weight of the material and the melamine fibers may be present between 40-60% by weight of the material. The spun-laced fibers may have a basis weight of between 50-90 grams per square meter.

In connection with the manufacture of the non-woven materials herein, containing aramid fiber in the first layer, it can be noted that given the inherent yellow color of the aramid fiber, it has been found that certain level of the aramid, in the non-woven, will cause the non-woven to similarly yellow, thereby providing an undesirable cosmetic effect for a mattress product. Accordingly, it has been found that such undesirable cosmetic feature can be addressed in the fire-blocking non-woven structure, containing an aramid fiber, wherein the needle punched web including the aramid fiber is needle punched or otherwise attached to a spunbond, a melt blown web or spunbond/meltblown composite material.

Accordingly, the spunbond or meltblown materials suitable for needle punching or otherwise attaching to the aramid based non-wovens of the present invention may comprise a polyolefin or polyester based material. The objective then is to select that amount of spunbond or meltblown material for combining with the aramid based non-woven web to attenuate the yellow color that is typical for the aramid base web. Accordingly, by attaching a spunbond or meltblown to the aramid based non-woven web, the yellow color of the aramid based web is whitened to provide a more cosmetically pleasing resultant product.

In a related embodiment to the above, it has also been found that one can prepare a cosmetically pleasing fire-blocking product by first supplying a carded web of an aramid based fiber, e.g., a carded web of aramid with a viscose fiber containing silicic acid (e.g., Visil™). The amount of aramid fiber may be at a level of equal to or greater than 10% (wt.), and for example, in the range of 10-60% (wt.), including all levels and ranges therebetween. The corresponding amount of viscose fiber may be present at a level between 40-90% (wt.), and at all levels and ranges therebetween.

Accordingly, other optional combinations of the first carded web may include 5-25% (wt.) aramid fiber in combination with 95-75% (wt.) of a viscose fiber containing silicic acid. Furthermore, the first carded web may include 5-25% (wt.) melamine/formaldehyde fiber in combination with 95-75% (wt.) of a viscose containing silicic acid.

The above is followed by supplying a second carded web comprising a polyacrylonitrile based composition, which composition may include a blend of polyacrylonitrile copolymer containing a halogen comonomer with a polyester polymer such as PET. In the case of such blend, the polyacrylonitrile copolymer containing a halogen co-monomer may be present at a level of 70-30% (wt.) and the polyester may be present at a level of 30-70% (wt.). Furthermore, the second carded web may include a blend of binder fiber and polyester polymer. The second carded web may also include natural fibers and/or a polyacrylonitrile copolymer with a halogen comonomer. The natural fibers may be composed of wool and/or cotton.

The two carded webs may then be needle-punched under conditions wherein the needle-punching may be controlled to the point wherein the yellow color of the aramid based carded web is whitened by the incorporation of the polyacrylonitrile web. One may further needle punch with a spunbond or meltblown web of polyolefin or polyester material.

In another exemplary embodiment, a polyester/polyamide blend or mattress ticking material may be unwound and on top of the blend or ticking a fiber fleece may be laid down. The fiber fleece may contain flame retardant material and be fed from a carding or related machine. A deep-drawing process may then be applied to bind the fiber fleece to the polyester/polyamide blend or mattress ticking material. The resulting three-dimensional product may be used for a variety of applications include, but not limited to, mattress borders or panels.

In another exemplary embodiment, polyester/polyamide blend or mattress ticking material may be unwound. On top of the blend or ticking a fiber fleece, containing the flame retardant materials described herein, may be laid down. The fleece may be fed from a carding or a related machine. Polyester or polypropylene spunweb may also be unwound and disposed on the other materials so as to sandwich the fiber fleece between the polyester/polyamide blend or mattress ticking material and the polyester or polypropylene spunweb. The deep-drawing process may then be applied to bind the three layers together.

The resulting three-dimensional product may be used in a variety of applications including, but not limited to, mattress borders or panels. This process may also be used to make tack and jump designs. A person of ordinary skill in the art would recognize that tack and jump designs are designs formed in discrete portions through-out the resulting three-dimensional product.

In another exemplary embodiment of the present invention a three-dimensional fiber network may be formed employing a layer of a flame retardant material and/or metallic film or foil combined with another layer of mattress ticking or a non-woven polyester/polyamide blend.

In another exemplary embodiment of the present invention a three dimensional fiber network may be formed from a center layer of a flame retardant material and/or metallic film or foil and a layer of mattress ticking or a non-woven polyester/polyamide blend combined with a layer of polyester spunweb or polyolefin spunweb. Preferably, the polyester or polyolefin spunweb serves to stiffen the composite structure and support the structure.

In another exemplary embodiment the flame retardant material may have a basis weight of between 50-90 grams per square meter. A layer of support material may also be included. The support material may include polyester or polypropylene. In one embodiment, the support material may be spunbond polyester having a denier of between 2-3 and a basis weight of between 20-70 grams per square meter. It should be appreciated that more than one layer of flame retardant and/or the support material may be included in the three dimensional fiber network. Furthermore, an adhesive layer may be incorporated between the layers of flame retardant material and support material.

The flame retardant material and support layer may be used in fire protection applications such as fire fighting turn-out gear or other fire protection equipment. The combinations of the flame retardant material, support material and/or adhesive may exhibit a thermal performance protection rating of 35 or greater, such as between 35-45 and any increment therebetween including 40, 41, etc., as measured by the National Fire Protection Agency Standard 1971, 2000 edition, available from the National Fire Protection Agency, Quincy, Mass.

The foregoing description is provided to illustrate and explain the present invention. However, the description hereinabove should not be considered to limit the scope of the invention set forth in the claims appended here to.

What is claimed is:

1. A fire blocking non-woven three-dimensional structure comprising a fabric having a multiplicity of compressible textile projections, said fabric comprising a layer of a fire blocking non-woven material, characterized in that said projections return substantially to their original shape after being compressed by 50%.

2. A mattress having a panel and/or a border comprising the fire blocking non-woven three-dimensional structure of claim 1.

3. The fire blocking non-woven structure of claim 1 wherein said fabric comprises filaments having a diameter of at least about 0.1 mm.

4. The fire blocking non-woven structure of claim 1 wherein said fabric comprises filaments having a diameter of less than about 0.1 mm.

5. The fire blocking non-woven three-dimensional structure of claim 1 wherein said layer of fire blocking non-woven material comprises
(a) a first fiber component containing polyacrylonitrile copolymer with a halogen containing monomer;
(b) a second fiber component comprising a viscose fiber containing silicic acid, or a melamine/formaldehyde fiber or a regenerated cellulose fiber; and
(c) a third fiber component comprising an aramid fiber, or a melamine/formaldehyde fiber, or a polyester fiber.

6. The fire blocking non-woven material of claim 5, wherein said third fiber component comprises an aramid fiber and said aramid fiber is present at a level of less than or equal to about 60.0% (wt.).

7. The fire blocking non-woven material of claim 5 wherein said first fiber component is present at a level of about 30-70% (wt.), said second fiber component is present at a level of about 10-50% (wt.), and said third fiber component is present at a level of about 10-30% (wt.).

8. The fire blocking non-woven material of claim 5 wherein said aramid fiber is poly(p-phenylene terephthalamide).

9. The fire blocking non-woven material of claim 5 wherein said polyester fiber is poly(ethylene terephthalate).

10. The fire blocking non-woven material of claim 5 wherein said needle-punched non-woven textile structure comprises 1.0-15.0 denier fibers.

11. The fire blocking non-woven material of claim 5 wherein said needle punched non-woven textile structure has a basis weight of about 100-350 g/m².

12. The fire blocking non-woven material of claim 5 wherein said regenerated cellulose fiber is a lyocell fiber.

13. The fire blocking non-woven material of claim 5, further including a binder fiber.

14. The fire blocking non-woven material of claim 13, wherein said binder fiber comprises a sheath/core, side-by-side or monofilament construction.

15. The fire blocking non-woven three-dimensional structure of claim 1 wherein said layer of fire blocking non-woven material comprises a needle-punched web including an aramid fiber, wherein said needle punched web including an aramid fiber is attached to a spunbond, melt blown or spunbond/meltblown composite web material.

16. The fire blocking non-woven material of claim 15, wherein said attached spunbond, melt blown or spunbond/meltblown composite web material is attached by needle-punching.

17. The fire blocking non-woven material of claim 15, wherein said aramid fiber is present at a level of greater than or equal to about 10%, thereby resulting in an initial yellow color, and said spunbond or melt blown web material functions to whiten said yellow color due to said aramid fiber.

18. The fire blocking non-woven material of claim 15 wherein said spunbond or melt blown web material is a polyolefin or polyester material.

19. The fire blocking non-woven material of claim 18 wherein said polyolefin is polypropylene.

20. The fire blocking non-woven material of claim 15, wherein said needle-punched textile web containing said aramid fiber comprises a first fiber component containing polyacrylonitrile copolymer with a halogen containing monomer and a second fiber component comprising a viscose fiber containing silicic acid.

21. The fire blocking non-woven three-dimensional structure of claim 1 wherein said layer of fire blocking non-woven material comprises a first carded web including an aramid and/or melamine/formaldehyde fiber and a second carded web comprising a blend of polyacrylonitrile copolymer with a halogen comonomer and a polyester polymer, wherein said first carded web including aramid and/or melamine/formaldehyde fiber is needle punched with said second carded web of said blend.

22. The fire blocking non-woven material of claim 21, wherein said aramid or melamine/formaldehyde fiber in said first carded web is present at a level of greater than or equal to about 10. % (wt.).

23. The fire blocking non-woven material of claim 21 wherein said second carded web comprises a blend of 30-70% (wt.) of polyacrylonitrile copolymer with a halogen comonomer and 70-30% (wt.) of polyester.

24. The fire blocking non-woven material of claim 21 wherein said first carded web comprises 5-25% (wt.) of aramid fiber in combination with 95-75% (wt.) of a viscose fiber containing silicic acid.

25. The fire blocking non-woven material of claim 21 wherein said first carded web comprises 5-25% (wt.) of melamine/formaldehyde fiber in combination with 95-75% (wt.) of a viscose fiber containing silicic acid.

26. The fire blocking non-woven material of claim 21 wherein said first carded web containing said aramid fiber has a yellow color, and said second carded web functions to whiten said yellow color.

27. The fire blocking non-woven material of claim 1 wherein said layer of fire blocking non-woven material comprises a first carded web including an aramide fiber and/or a melamine/formaldehyde fiber and a second carded web comprising a blend of binder fiber and a polyester polymer, wherein said first carded web contacts said second carded web of said blend.

28. The fire blocking non-woven material of claim 27 wherein said first carded web comprises 5-25% (wt.) of aramid fiber in combination with 95-75% of a viscose fiber containing silicic acid.

29. The fire blocking non-woven material of claim 27 wherein said first carded web comprises 5-25% (wt.) of melamine/formaldehyde fiber in combination with 95-75% (wt.) of a viscose fiber containing silicic acid.

30. The fire blocking non-woven material of claim 27 wherein said second carded web further includes natural fibers and/or a polyacrylonitrile copolymer with a halogen comonomer.

31. The fire blocking non-woven material of claim 30 wherein said natural fibers comprise wool and/or cotton.

32. The fire blocking non-woven three-dimensional structure of claim 1 wherein said fabric further comprises a layer of a polyester/polyamide blend or mattress ticking.

33. The fire blocking non-woven three-dimensional structure of claim 32 wherein said polyester/polyamide blend is spunbond and hydroentangled.

34. The blocking non-woven three-dimensional structure of claim 1 wherein said fabric further comprises a layer of a spunweb of thermoplastic material.

35. The fire blocking non-woven three-dimensional structure of claim 34 wherein the thermoplastic material may be selected from the group consisting of polyester, polypropylene and mixtures thereof.

36. The fire blocking non-woven three-dimensional structure of claim 1 wherein said fabric further comprises an adhesive.

37. The fire blocking non-woven three-dimensional structure of claim 36 wherein said fabric further comprises an adhesive disposed between said fire blocking material and said polyester/polyamide blend.

38. The fire blocking non-woven three-dimensional structure of claim 1 wherein said fabric further comprises a layer selected from the group consisting of polyester/polyamide blend and/or mattress ticking and a layer of spunweb, said spunweb is selected from the group consisting of polyester, polypropylene and mixtures thereof.

39. The fire blocking non-woven three dimensional structure of claim 38 wherein said fabric further comprising an adhesive layer disposed between said fire blocking layer, said polyester/polyamide blend and/or mattress ticking layer and spunweb layer.

40. The fire blocking non-woven three dimensional structure of claim 1 wherein said fire blocking non-woven material comprises a first layer of melamine and aramid fibers.

41. The fire blocking non-woven three dimensional structure of claim 40 wherein said fabric further comprises a second layer of fibers selected from the group consisting of polyester, copolyester, polypropylene and combinations thereof.

42. The fire blocking non-woven three dimensional structure of claim 40 wherein said aramid fibers include para-aramid and meta-aramid fibers.

43. The fire blocking non-woven three dimensional structure of claim 40 wherein said fabric further comprises a third layer of binder fibers.

44. The fire blocking non-woven three dimensional structure of claim 43 wherein said binder fibers include copolyamide fibers.

45. The fire blocking non-woven three dimensional structure of claim 40 wherein said structure has a TPP rating of greater than about 35.

46. A fire blocking non-woven three-dimensional structure comprising a fabric having a multiplicity of compressible textile projections, said fabric comprising a layer of a fire blocking metallic film or foil, characterized in that said projections return substantially to their original shape after being compressed by 50%.

47. The fire blocking non woven structure of claim 46 wherein said fabric includes a polyester/polyamide blend.

48. The fire blocking non woven structure of claim 46 wherein said fabric further includes a polyester or polypropylene spunweb.

49. The fire blocking non woven structure of claim 46 further including an adhesive.

50. The method of forming a three-dimensional fire blocking non-woven structure comprising:
providing a polyester/polyamide blend or mattress ticking;
providing a flame retardant fiber fleece;
laying said polyester/polyamide blend or mattress ticking down on said fiber fleece;
deforming said polyester/polyamide blend or mattress ticking and said fiber fleece; and
binding said polyester/polyamide blend or mattress ticking and said fiber fleece.

51. The method of claim 50 further comprising disposing an adhesive between said polyester/polyamide blend or mattress ticking and said fiber fleece.

52. The method of forming a three-dimensional fire blocking non-woven structure comprising:
providing a polyester/polyamide blend or mattress ticking;
providing a flame retardant fiber fleece;
providing a spunweb, selected from the group consisting of polyester, polypropylene and mixtures thereof;
disposing said polyester/polyamide blend or mattress ticking on said fiber fleece;
disposing said spunweb on said fiber fleece and said polyester/polyamide blend or mattress ticking;
deforming said fiber fleece, said polyester/polyamide blend or mattress ticking and said spunweb; and
binding said fiber fleece, said polyester/polyamide blend or mattress ticking and said spunweb.

53. The method of claim 52 further comprising disposing an adhesive between said polyester/polyamide blend or mattress ticking, said fiber fleece and said spunweb.
